(19) United States
(12) Patent Application Publication
(10) Pub. No.: US 2005/0086941 A1
(43) Pub. Date: Apr. 28, 2005

(54) Afterburner arrangement

(75) Inventors: Jacques Bunel, Fresnes (FR); Jacques Roche, Lisses (FR); Bien-Aime Rakotondrainibe, Arbonne la Foret (FR); Stephane Touchaud, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 10/898,999

(22) Filed: Jul. 27, 2004

(30) Foreign Application Priority Data
Aug. 5, 2003 (FR) 03 09657

(51) Int. Cl. F02K 3/10

(52) U.S. Cl. 60/761

(57) ABSTRACT

The invention relates to an afterburner ring 19 for turbofan jet engines. The ring comprises an upstream annular envelope which forms a channel which is open axially in the downstream direction, and a manifold 4 for injecting fuel into the channel. The ring has sectors 20 which each comprise a sector 1 of the upstream annular envelope. Each sector 1 has a fuel inlet 35 which is connected to the injection manifold 4. Part of the upstream annular envelope is in the core flow. Each sector 20 has a connecting means which receives the fuel inlet and a ventilation duct 2 which extends through the channel along the sector 1, at a point upstream of the injection manifold 4. Each sector 1 is fitted with an inlet for bypass air, which air is then emitted by the ventilation duct 2 to cool the injection manifold 4. A sector 5 of downstream annular envelope is arranged downstream of the injection manifold 4 to protect it.

The invention relates to the field of turbofan jet engines and more particularly to afterburner arrangements.

Turbofan jet engines have a flow of exhaust gases termed the core flow which is at a higher temperature than a flow of air termed the bypass flow. It is known that turbofan jet engines have an afterburner arrangement. This latter comprises an annular outer casing having, within it, an annular exhaust casing which is spaced away from the annular outer casing and which comprises annular inner and outer walls whose axis of revolution is the same as the axis of rotation of the jet engine. The outer wall and the annular outer casing define a passage for the bypass flow, and the annular outer wall and the annular inner wall define a passage for the core flow. After first combustion which releases the flow of exhaust gases (the core flow) through the high-pressure and low-pressure turbines, the engine has an arrangement which employs the injection of fuel into the core flow and the bypass flow to initiate second combustion. There are known afterburner arrangements which comprise a burner ring situated in the bypass flow, and flameholder arms which are situated in the core flow where the latter has been mixed with part of the bypass flow. There are also known afterburner arrangements which comprise a burner ring situated in the core flow. The result of these positions is high thermal stresses.

The present invention proposes to improve the afterburner arrangement.

The invention relates to an afterburner ring for turbofan jet engines, a flow of exhaust gases termed the core flow being at a higher temperature than a flow of air termed the bypass flow, the ring having an axis of revolution suitable for being positioned to coincide with the axis of rotation of the jet engine, the ring comprising on the one hand an upstream annular envelope forming a channel which is open axially in the downstream direction, and on the other hand a fuel injection manifold arranged in the channel, the ring being formed by a plurality of sectors of ring which are connected together and which each comprise a sector of the upstream annular envelope, each sector of the upstream annular envelope being fitted with a fuel inlet which is connected to the fuel injection manifold.

According to a main feature of the invention, the upstream (or outer) surface of the upstream annular envelope is suitable for being in contact with the core flow. What is more, each sector of ring comprises a connecting means which is arranged in the channel at a point upstream of the fuel injection manifold to receive on the one hand the fuel inlet and on the other hand a ventilation duct which extends along the channel, for at least part of the length of the upstream annular envelope, at a point upstream of the fuel injection manifold, each sector of the upstream annular envelope being provided with an inlet for bypass air, which air is then emitted by the ventilation duct to cool the fuel injection manifold. Also, a sector of downstream annular envelope is arranged downstream of the fuel injection manifold to protect the latter.

The invention also relates to an afterburner arrangement for turbofan jet engines, a flow of exhaust gases termed the core flow being at a higher temperature than a flow of air termed the bypass flow, the arrangement comprising an annular outer casing having, within it, an annular exhaust casing which is spaced away from the annular outer casing and which comprises annular inner and outer walls whose axis of revolution is the axis of rotation of the jet engine, the outer wall and the annular outer casing defining a passage for the bypass flow and the annular outer wall and the annular inner wall defining a passage for the core flow, the arrangement also comprising afterburner arms.

In accordance with a main feature of the invention, the outer wall has orifices and the arrangement comprises the afterburner ring as previously defined, which is fixed to the annular outer wall in such a way that the upstream surface of the upstream annular envelope is in contact with the core flow and that the inlet for bypass air belonging to each sector of the upstream annular envelope coincides with an orifice in the outer wall.

The accompanying drawings show embodiments of the invention by way of non-limiting example. In the drawings:

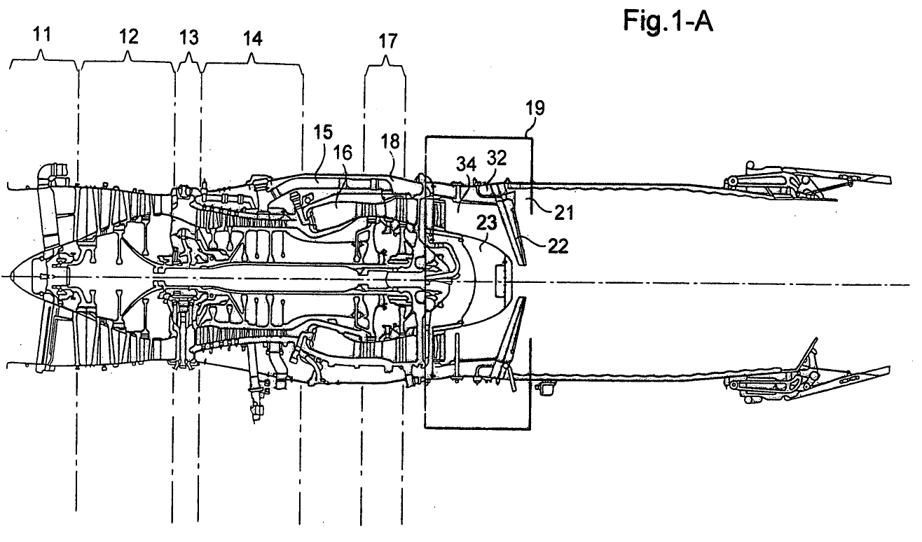

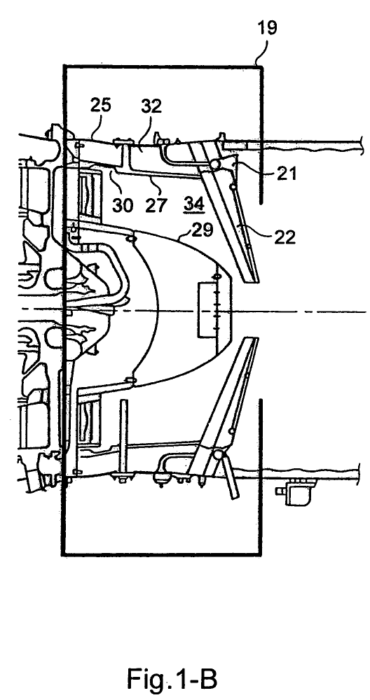

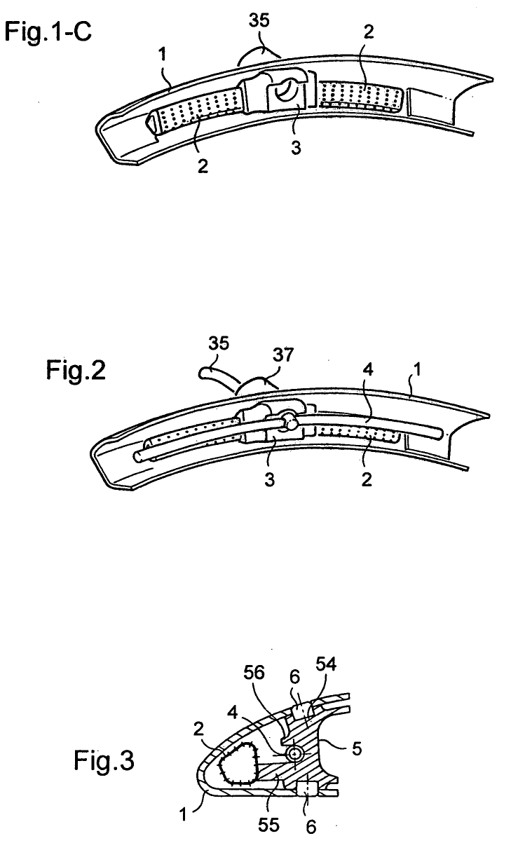

FIG. 1A is a view in section of a turbofan jet engine.

FIG. 1B shows a detail of the section through a turbofan jet engine which is shown in FIG. 1A.

FIG. 1C is a perspective view of a sector of burner ring in a first phase of assembly according to the invention.

FIG. 2 is a perspective view of a sector of burner ring in a second phase of assembly according to the invention.

FIG. 3 is a section through the sector of burner ring on line A-A in FIG. 5.

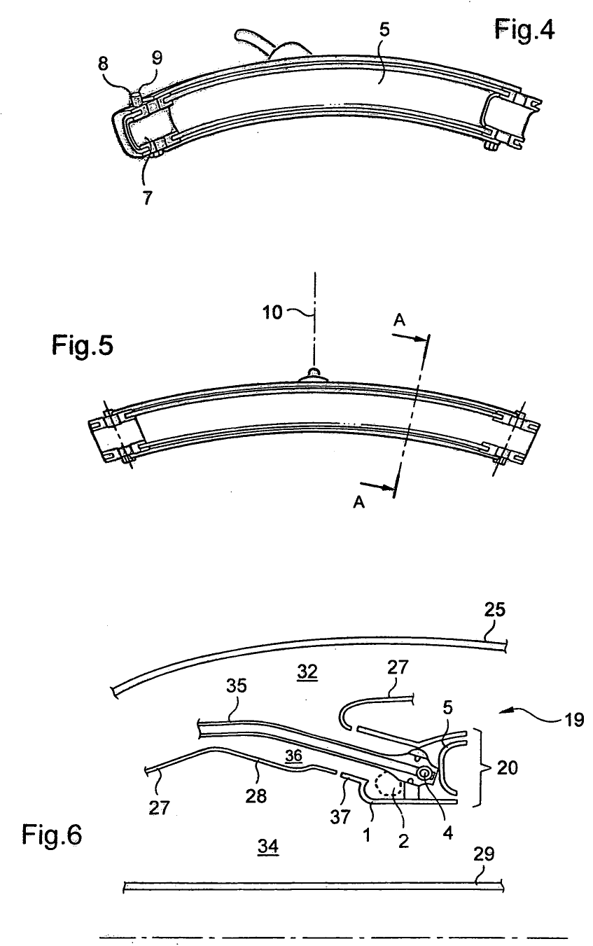

FIG. 4 is a perspective view of the sector of burner ring fitted with attaching end-pieces at its ends.

FIG. 5 is a view looking downstream of the sector of burner ring fitted with attaching end-pieces at its ends.

FIG. 6 is a schematic general arrangement drawing of the afterburner arrangement, which here comprises only the burner ring according to the invention.

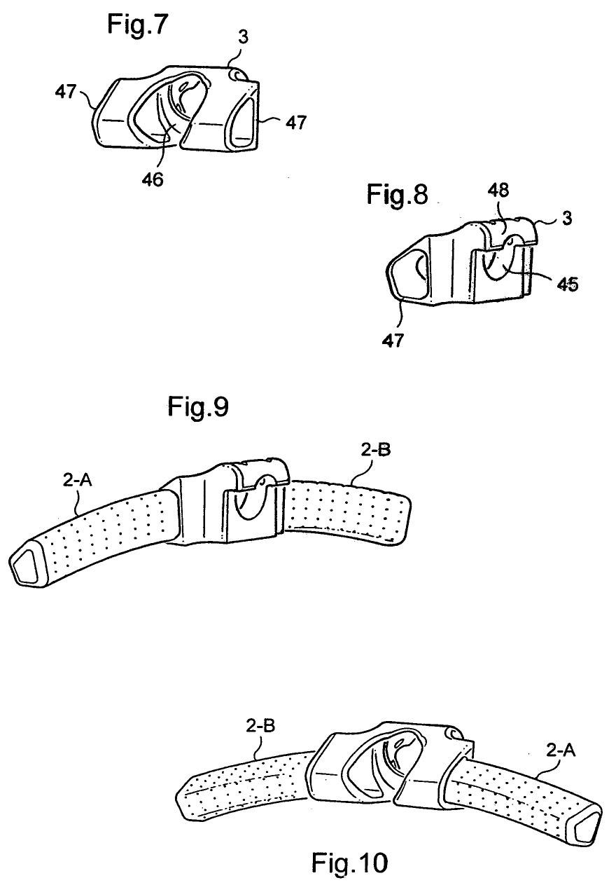

FIG. 7 is a perspective view of the connecting end-piece looking from upstream.

FIG. 8 is a perspective view of the connecting end-piece looking from downstream.

FIG. 9 is a perspective view, looking from downstream, of the connecting end-piece when connected to the ventilation duct.

FIG. 10 is a perspective view, looking from upstream, of the connecting end-piece when connected to the ventilation duct.

The drawings contain, in the main, items which are of a set nature. They can therefore serve not only to enable the description to be better understood but also to assist, where applicable, in defining the invention.

FIG. 1A is a diagram of a turbofan jet engine.

The air is first drawn in by the intake fan 11 and is then directed into the low-pressure compressor 12. One part of the flow of air which has been compressed is directed into the high-pressure compressor 14 and the other part into part 18 of the engine. On leaving the combustion chamber 16, the exhaust gases are directed into the high-pressure turbine and then the low-pressure turbine 17 before being directed into the exhaust casing 23. These high-temperature exhaust gases represent a core flow. The flow of cold air in part 18 of the turbofan is heated by contact with the passage 15 for hot air. The heated flow of air is called the bypass flow.

The afterburner arrangement 19 will now be explained by reference to the detail view in FIG. 1B. The afterburner arrangement comprises an outer annular casing 25 which has, within it and at a distance from it, an annular exhaust casing. The two casings have the same axis of revolution, which is the same as the axis of rotation of the jet engine. The annular exhaust casing comprises an annular inner wall 29 and an annular outer wall 27, the axis of revolution of which walls is the axis of rotation of the engine, the outer wall 27 and the annular outer casing 25 defining a passage 32 for the bypass flow after it has passed through part 18, the annular outer wall 27 and the annular inner wall 29 defining a passage 34 for the core flow after it has passed through the turbines 17. An orifice 30 in the annular outer wall 27 allows a passageway to be left open to enable the bypass flow to mix with the core flow in the passage 34. A fuel inlet mechanism in the passage 34 enables the core-flow/bypass flow/fuel mixture to be caused to burn, the flames attaching themselves to the flameholder arms 22. As indicated in FIG. 1B, the arms are connected to the outer casing and extend downstream at an angle of inclination to a plane perpendicular to the axis of rotation. What is more, a burner ring 21 is positioned in the bypass flow and is made up of sectors of ring arranged between the flameholder arms. The upstream annular envelope of the burner ring protects a fuel injection manifold, which sprays fuel in the downstream direction to maintain the afterburning, against the afterburner flames and against the high-temperature (900° C.) core flow.

To improve the efficiency of the afterburning, the burner ring is positioned in the core flow. This arrangement gives rise to very high thermal stresses at the burner ring. Therefore, in accordance with the invention, the latter is produced in such a way that the thermal stresses are reduced and the efficiency of the afterburning improved.

FIG. 6 is a schematic section through the afterburner arrangement according to the invention. The arrangement comprises a burner ring which comprises on the one hand an upstream annular envelope forming a channel which is open axially in the downstream direction, and on the other hand a fuel injection manifold 4 arranged in the channel, the burner ring being formed by a plurality of sectors of ring 20 which are connected together and which each comprise a sector 1 of the upstream annular envelope, each sector 1 of the upstream annular envelope being fitted with a fuel inlet 35 which is connected to the fuel injection manifold 4. Solely by way of example, the upstream annular envelope is formed by an annular dihedral whose rounded apex is directed upstream, the inner plane of the dihedral being parallel to the axis of rotation and the outer plane being directed radially outwards. As shown in FIG. 6, the annular outer wall 27 contains, in a plane perpendicular to the axis of rotation, orifices 36 which are regularly spaced around the entire circumference of the outer annular wall 27. These orifices 36 are defined by a section of tube 28 extending downstream, said open-ended section of tube 28 being, by, way of example, in one piece with the inner annular wall 27 by casting. The section of tube 28 extends downstream at an angle of inclination to a plane perpendicular to the axis of rotation. Each sector of the downstream annular envelope of the burner ring, and more particularly each outer plane of each sector, contains an orifice which is defined by a section of tube 37 which extends upstream at an angle of inclination to a plane perpendicular to the axis of rotation. The orifice in the sector of the upstream annular envelope is adapted to coincide with and to be fixed to one of the orifices in the outer annular wall 27.

The orifice in the sector of the upstream annular envelope acts as an inlet for bypass air and an inlet for fuel into the channel formed by the sector of the upstream annular envelope. Another embodiment of the orifices could be envisaged to enable the air inlet to be dissociated from the fuel inlet. The inlet of fuel takes place more particularly through a tube 35 which passes through the coincident orifices in the annular outer wall and the sector of the upstream annular envelope. At its end, the tube 35 opens into a connecting head, which head is connected to the fuel injection manifold arranged in the channel defined by the sector of the upstream annular envelope. The fuel injection manifold 4 extends over at least a part of the sector 1 of the upstream annular envelope and is formed by a tube which is perforated in the downstream direction. In the very high-temperature environment resulting from the position of the burner ring in the core flow, it is necessary for each sector of the burner ring to be ventilated and cooled to avoid excessively high thermal stresses. To improve the ventilation of the upstream annular envelope and the fuel injection manifold, a ventilation duct 2 is arranged in the channel at a point upstream of the fuel injection manifold 4 and is fed by the air inlet. FIG. 1C shows the fitting of the ventilation duct into the channel, prior to the fitting of the fuel injection manifold which is shown in FIG. 2. Each tube of the ventilation duct is provided with local bosses, termed studs, to ensure there is a gap between the sector of upstream annular envelope and the ventilation duct.

Each sector of burner ring has a connecting end-piece 3 which is arranged in the channel at a point upstream of the fuel injection manifold, to receive on the one hand the fuel inlet pipe and the air inlet, and on the other hand the ventilation duct, which latter extends along the channel for at least part of the length of the sector of the upstream annular envelope and at a point upstream of the fuel injection manifold. The connecting end-piece is shown in detail particularly in FIGS. 7, 8, 9 and 10.

The shape of the connecting end-piece 3 is complementary to that of the channel formed by the upstream annular envelope to allow it to be positioned upstream of the fuel injection manifold. The end-piece contains a main cavity which is able to be positioned opposite the orifice in the sector of the upstream annular envelope and which is able to receive the connecting head of the fuel inlet and air inlet. The main cavity opens onto a downstream opening 45 to enable the connecting head to be connected to the fuel injection manifold, which latter is arranged perpendicularly to the direction of the connecting head. To stop the connecting head from rotating in the cavity which opens onto the downstream opening, the connecting end-piece has a projection 48 which extends axially and is positioned radially outwards from the downstream opening. The connecting end-piece 3 also has lateral openings, that is to say openings at opposite ends which face in the direction of the circumference of the ring on either side of the main air inlet cavity. The lateral openings enable the ventilation duct to be fitted. The ventilation duct advantageously comprises two multiply perforated hollow tubes each adapted to be held at their open end in one of the two lateral openings, the free ends of the tubes opening into the main cavity. The air which enters through the orifice in the sector of the upstream annular envelope passes into the main cavity, which forms an air inlet receptacle, and is directed laterally and circumferentially into the hollow tubes of the ventilation duct through the ends of the tubes which are positioned in the lateral openings in the connecting end-piece.

To protect the fuel injection manifold and the ventilation duct from flash-backs and radiant heat, a sector 5 of downstream annular envelope is arranged downstream of the said manifold in the channel defined by the sector of upstream annular envelope. The sector of downstream annular envelope is broadly semi-circular in axial section, the ends of the axial section forming, with respective ends of the planes of the downstream annular envelope, passages for the fuel coming from the fuel injection manifold. The sector 5 of downstream annular envelope forms a screen for the thermal protection of the burner ring in the downstream direction.

The sector of downstream annular envelope forms a channel which is open axially in the downstream direction, and it is fixed by fixing means to the sector of the upstream annular envelope. These fixing means may be a rivet. As shown in FIG. 3, the sector 5 of downstream annular envelope comprises holding means which are positioned axially upstream of the sector to hold the fuel injection manifold in place, and to hold the ventilation duct in place against the inside wall of the sector of upstream annular envelope, and to make a point connection between the sector of downstream annular envelope and the downstream surface of the sector of upstream annular envelope. These holding means are for example webs 54 (such as two webs per sector, for example) of a small circumferential width which are integrally cast with the sector of downstream annular envelope on the upstream side of the latter. A web 54 is shown in section in FIG. 3. The web 54 has an inner tongue 55 which extends axially upstream of the sector of downstream annular envelope so that, once the sector of downstream annular envelope is correctly positioned in the channel formed by the sector of upstream annular envelope, the said inner tongue 55 will press one of the tubes of the ventilation duct against the apex part of the channel. An outer tongue 56 of the web 54 defines, with the inner tongue 55, a concave cavity to receive the fuel injection manifold to hold the latter spaced a certain distance away from the upstream surface of the sector 5 of downstream annular envelope. Hence, the sector 5 of downstream annular envelope performs the function of a screen for thermal protection satisfactorily. The web 54 also has, at its inner and outer radial ends, cavities which are to be lined up with holes formed in the sector of upstream annular envelope to allow studs 6 which pass through the holes to come to rest in the cavities. The studs 6 are welded to allow the sectors of upstream and downstream annular envelope to be fixed together. Other means for fixing the sectors of the upstream and downstream annular envelopes together may be envisaged to enable the screen for thermal protection to be removed for the purpose of maintaining the burner ring.

FIGS. 4 and 5 show a sector of the burner ring which is fitted at its ends with end-pieces for lateral attachment to enable the sector to be attached to another sector at each end. In this way, the sectors of ring are connected together by end-pieces for lateral attachment which comprise a part which is provided, at its ends facing the ends of the sectors of ring, with grooves into which the ends of the sectors of downstream annular envelope fit. The end-pieces for lateral attachment are also used to fix the sectors of ring to the afterburner arms by a pin 8 and retaining pin 9.

The presence of the end-pieces for lateral attachment enables the sectors of ring to expand freely, since the ends of the latter are not held immobile. The rivet 10 does however enable the complete assembly to be held fixed in place.

The invention is not limited to the embodiments of fixing and attachment device which have been described above solely by way of example but does in fact cover any variant which might be envisaged by the person skilled in the art within the scope of the following claims.

1. Afterburner ring for turbofan jet engines, a flow of exhaust gases termed the core flow being at a higher temperature than a flow of air termed the bypass flow, the ring (21) having an axis of revolution suitable for being positioned to coincide with the axis of rotation of the jet engine, the ring (21) comprising on the one hand an upstream annular envelope forming a channel which is open axially in the downstream direction, and on the other hand a fuel injection manifold (4) arranged in the channel, the ring (21) being formed by a plurality of sectors of ring (20) which are connected together and which each comprise a sector (1) of the upstream annular envelope, each sector (1) of the upstream annular envelope being fitted with a fuel inlet (35) which is connected to the fuel injection manifold (4), characterised in that the upstream surface of the upstream annular envelope is suitable for being in contact with the core flow, in that each sector of ring (20) comprises a connecting means (3) which is arranged in the channel at a point upstream of the fuel injection manifold (4) to receive on the one hand the fuel inlet (35) and on the other hand a ventilation duct (2) which extends along the channel, for at least part of the length of the sector of upstream annular envelope, at a point upstream of the fuel injection manifold (4), each sector (1) of the upstream annular envelope being provided with an inlet for bypass air, which air is then emitted by the ventilation duct (2) to cool the fuel injection manifold (4), and in that a sector (5) of a downstream annular envelope is arranged downstream of the fuel injection manifold (4) to protect the latter.

2. Afterburner ring according to claim 1, characterised in that the sector (5) of downstream annular envelope forms a channel which is open axially in the downstream direction, and is fixed by fixing means to the sector (1) of the upstream annular envelope.

3. Afterburner ring according to claim 1, characterised in that the sector (5) of downstream annular envelope comprises holding means which are positioned axially upstream to hold the fuel injection manifold (4) in place, and to hold the ventilation duct (2) in place against the inside wall of the sector (1) of upstream annular envelope, and to connect the sector (5) of downstream annular envelope to the inside wall of the sector (1) of upstream annular envelope

4. Afterburner ring according to claim 1, characterised in that the connecting means (3) contains a single cavity which forms a receptacle for the fuel inlet (35) and for the bypass air inlet.

5. Afterburner ring according to claim 1, characterised in that the ventilation duct (2) comprises two multiply perforated hollow tubes, the connecting means (3) having two openings situated opposite one another along the circumference, which openings are situated on either side of the cavity forming the air inlet receptacle, the first and second tubes each being held at their open end in one of the two openings, the open ends of the tubes opening into the main cavity which forms the air inlet receptacle.

6. Afterburner ring according to claim 1, characterised in that the sectors of ring (20) are connected together by end-pieces for lateral attachment which comprise a part provided with grooves into which the ends of the sectors (5) of downstream annular envelope fit.

7. Afterburner ring according to claim 1, characterised in that the curvature of the upstream surface of the connecting means (3) is complementary to the curvature of the downstream surface of the upstream envelope.

8. Afterburner arrangement for turbofan jet engines, a flow of exhaust gases termed the core flow being at a higher temperature than a flow of air termed the bypass flow, the arrangement comprising an annular outer casing (25) having, within it, an annular exhaust casing which is spaced away from the annular outer casing (25) and which comprises annular inner (29) and outer (27) walls whose axis of revolution is the axis of rotation of the jet engine, the outer wall and the annular outer casing defining a passage for the bypass flow and the annular outer wall (27) and the annular inner wall (29) defining a passage for the core flow, the arrangement also comprising afterburner arms (22), characterised in that the outer wall (27) has orifices and in that the arrangement comprises an afterburner ring (21) as claimed in one of the foregoing claims which is fixed to the annular outer wall (27) in such a way that the upstream surface of the upstream annular envelope is in contact with the core flow and that the inlet for bypass air belonging to each sector (1) of the upstream annular envelope coincides with an orifice in the outer wall (27).

9. Afterburner arrangement according to claim 8, characterised in that the upstream annular envelope rests against the back of the afterburner arms (22), the sectors (1) of the upstream annular envelope being fixed together and to the backs of the afterburner arms (22) by fixing means which are applied to attaching end-pieces which comprise a part provided with grooves into which the ends of the sectors (5) of downstream annular envelope fit.

10. Jet engine comprising an afterburner arrangement according to claim 8.
